(19) United States
(12) Patent Application Publication
(10) Pub. No.: US 2013/0127338 A1
(43) Pub. Date: May 23, 2013

(54) Drive Circuit Structure for LED Lamp Tube

(71) Applicants: Cheng-Ming LEE, Jhubei City (TW); Ruei-Jhih Jheng, Jhubei City (TW); Feng-Pin Lee, Jhubei City (TW)

(72) Inventors: Cheng-Ming LEE, Jhubei City (TW); Ruei-Jhih Jheng, Jhubei City (TW); Feng-Pin Lee, Jhubei City (TW)

(21) Appl. No.: 13/494,141

(22) Filed: Jun. 12, 2012

(30) Foreign Application Priority Data
Nov. 22, 2011 (TW) 100222072

(51) Int. Cl. H01J 7/44

(52) U.S. Cl. 315/52

(57) ABSTRACT

A drive circuit structure for LED lamp tube is disclosed, wherein the LED lamp tube comprises a lampshade, at least an LED lamp strap and at least a drive circuit structure. The LED lamp strap is disposed inside the lampshade, and drive circuit structure connected with the LED lamp strap is disposed on any side within the lampshade. Moreover, the drive circuit structure includes multiple general-sized electronic components, at least a large-sized electronic component and a drive circuit board, wherein such general-sized electronic components are inserted on a plane of the drive circuit board, and the large-sized electronic component is disposed upright on any side of the drive circuit board. Accordingly, though the large-sized electronic component becomes voluminous, by disposing it upright on one side of the drive circuit board, it is possible to prevent the drive circuit structure from occupying larger accommodation space due to the large-sized electronic component.

### CROSS-REFERENCE TO RELATED APPLICATION

The current application claims a foreign priority to the patent application of Taiwan No. 100222072 filed on Nov. 22, 2011.

### BACKGROUND OF THE INVENTION

1. Field of the Invention

The present invention generally relates to a drive circuit structure for light-emitting diode (LED) lamp tube. In particular, the present invention concerns a drive circuit structure installed in the interior of an LED lamp tube thereby preventing the large-sized electronic component from occupying larger accommodation space.

2. Description of Related Art

Featuring many advantages such as better power saving, longer life span, smaller size and faster reaction speed or the like, light emitting diodes (LEDs) are at present comprehensively applied in various illumination fields. Now certain manufacturers have developed the LED lamp tube allowable for replacement of fluorescent lamps. As shown in FIGS. 1A, 1B and 2, a general LED lamp tube 1 comprises a long-strapped lampshade 11 for receiving an

LED lamp strap 12 and a drive circuit 13, and the long-strapped lampshade 11 is internally installed with two LED lamp straps 12 respectively placed on left side and right side, with each LED lamp strap 12 including multiple LED lamps 121; besides, in correspondence with each of the left and right LED lamp straps 12, the drive circuit 13 connected with the LED lamp strap 12 is individually disposed on both sides of the interior of the long-strapped lampshade 11. Meanwhile, in the drive circuit 13, a transformer 132 is set up by insertion on the drive circuit board 131 for the required electric power supply.

However, such a configuration method of placing two LED lamp straps 12 respectively on left and right sides within the long-strapped lampshade 11 will inevitably lead to the occurrence of a gap between these two left and right LED lamp straps 12. Although such two LED lamp straps 12 may be very close to each other, the luminance on either the left or right side is still higher than the one observed at the central portion. Hence, the LED lamp tube 1 may not illuminate completely and uniformly on the entire tube, so the illumination efficiency of the LED lamp tube 1 is reduced.

Regarding to this issue, therefore, some manufacturers attempted to place only one longer LED lamp strap 12 inside the long-strapped lampshade 11, while this LED lamp strap 12 is also driven for illumination by a drive circuit 13. Nevertheless, driving an entire piece of LED lamp strap 12 of greater length indeed requires a bigger power source to provide sufficient drive power, so the size of the transformer 131 in use also unavoidably becomes more voluminous as the supplied electric power increases. On the other hand, to place a transformer 132 of increased size into the long-strapped lampshade 11, the size thereof may be overly large so that the drive circuit 13 can not be set up on one side of the interior of the long-strapped lampshade 11, accordingly impossible to drive an entire piece of LED lamp strap 12. Suppose this issue is resolved, driving an entire piece of LED lamp strap 12 in the LED lamp tube 1 can be well achieved.

Therefore, it is desirable that, suppose a transformer of increased size can be installed on any side of the drive circuit, then the accommodation space occupied by the drive circuit can be effectively reduced such that the entire piece of LED lamp strap can be driven by a drive circuit having an electronic component of larger size in the LED lamp tube, thus providing an optimal solution.

### SUMMARY OF THE INVENTION

The objective of the present invention is to provide a solution capable of preventing a large-sized electronic component from occupying larger accommodation space in order to drive an entire piece of LED lamp strap by means of a drive circuit in the LED lamp tube.

A drive circuit structure for LED lamp tube capable of achieving the aforementioned objective is disclosed, wherein the LED lamp tube comprises a lampshade, at least an LED lamp strap and at least a drive circuit structure. The LED lamp strap is disposed in the interior of the lampshade, and drive circuit structure connected with the LED lamp strap is also disposed on any side of the interior of the lampshade. Moreover, the drive circuit structure includes multiple general-sized electronic components, at least a large-sized electronic component and a drive circuit board, in which such general-sized electronic components are inserted on any plane of the drive circuit board, and the large-sized electronic component can be installed on one side of the drive circuit board.

More specifically, the aforementioned LED lamp strap includes a plurality of LEDs.

More specifically, the aforementioned lampshade is of a long-strapped shape.

More specifically, the aforementioned drive circuit structure is connected with the LED lamp strap, and the drive circuit board of the drive circuit structure is used to drive the LED lamp strap to illuminate.

More specifically, the aforementioned general-sized electronic components can be electronic components such as resistors or capacitors and the like.

More specifically, the aforementioned large-sized electronic component is a transformer which is used to supply electric power required for the drive circuit board and the LED lamp strap to illuminate.

### BRIEF DESCRIPTION OF THE DRAWINGS

FIG. 1A shows an assembled structural diagram of a prior art LED lamp tube;

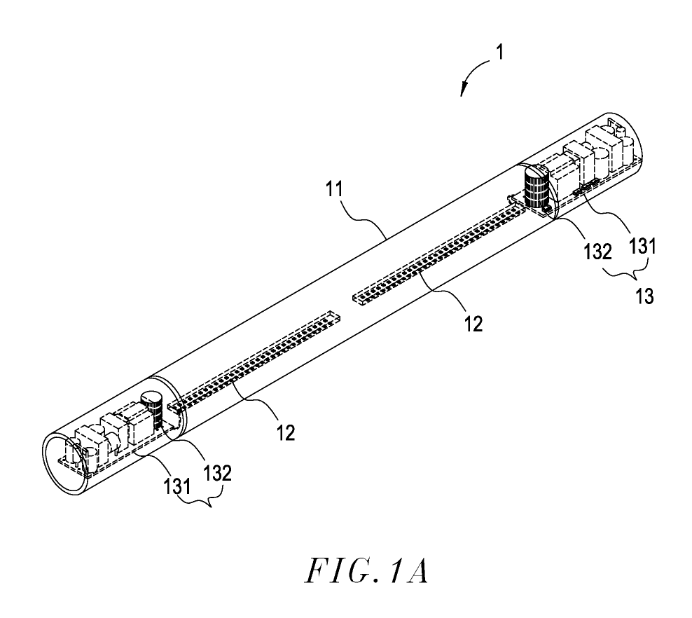

FIG. 1B shows a disassembled structural diagram of a prior art LED lamp tube;

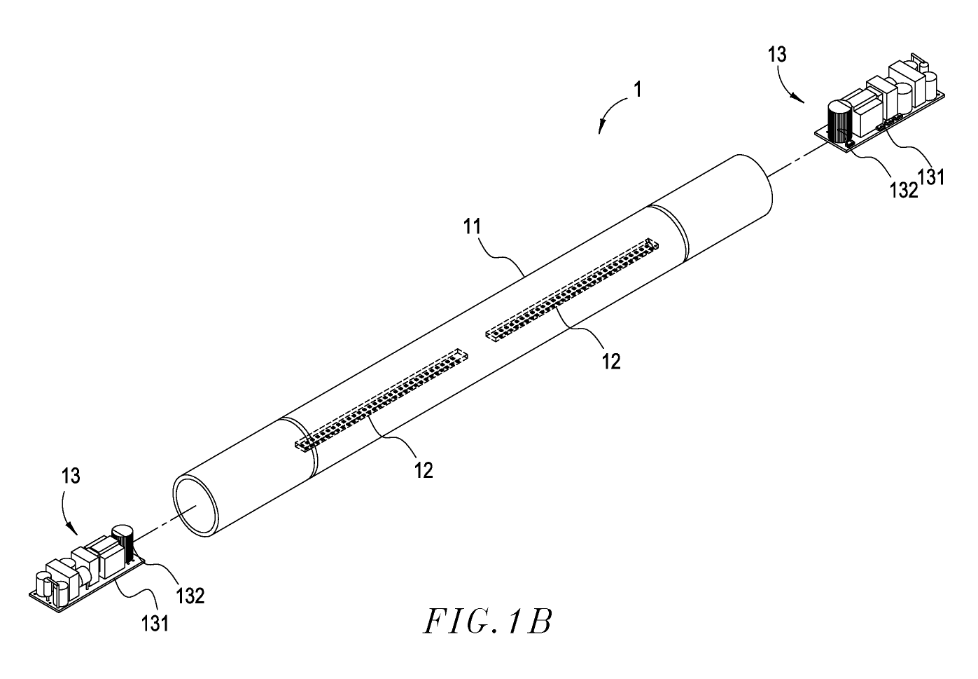

FIG. 2 shows a structural side view of a prior art LED lamp tube;

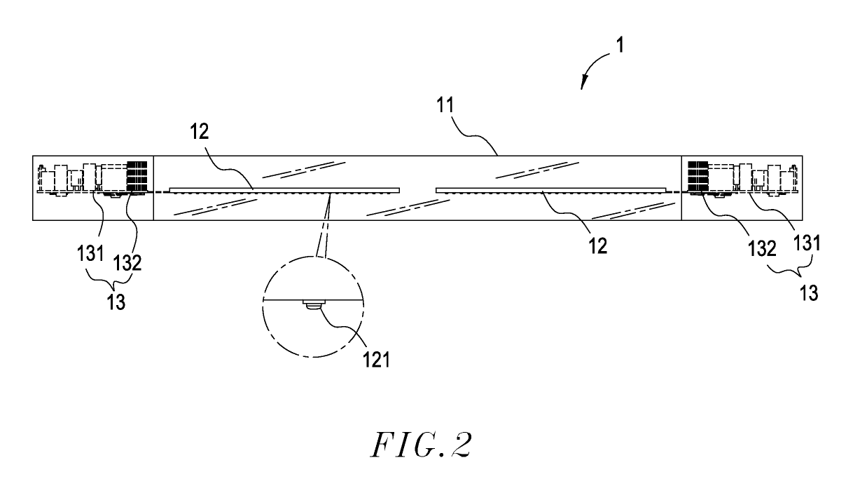

FIG. 3 shows a structural diagram of a drive circuit structure for LED lamp tube according to the present invention;

FIG. 4A shows an assembled structural diagram of a drive circuit structure for LED lamp tube according to the present invention with an LED lamp tube;

FIG. 4B shows a disassembled structural diagram of a drive circuit structure for LED lamp tube according to the present invention with an LED lamp tube; and

FIG. 5 shows a structural side view of a drive circuit structure for LED lamp tube according to the present invention with an LED lamp tube.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

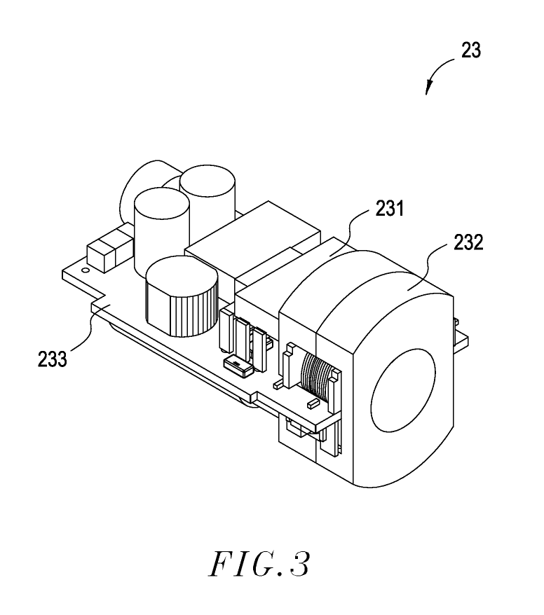

Refer next to FIG. 3, wherein a structural diagram of the drive circuit structure for LED lamp tube according to the present invention is shown. It can be seen from this figure that the drive circuit structure 23 comprises multiple general-sized electronic components 231 (for example, electronic components like resistors or capacitors and so forth), at least a large-sized electronic component 232 and a drive circuit board 233. Since it is to drive the LEDs 221 (the LED lamp) on the entire piece of the LED lamp strap 22, a transformer of larger size is required and accordingly represents the large-sized electronic component 232 indicated as above. It can be appreciated from the Figure that the large-sized electronic component 232 is placed upright on one side of the drive circuit board 233, rather than inserted thereon, so the accommodation space occupied by the drive circuit structure 23 can be effectively reduced.

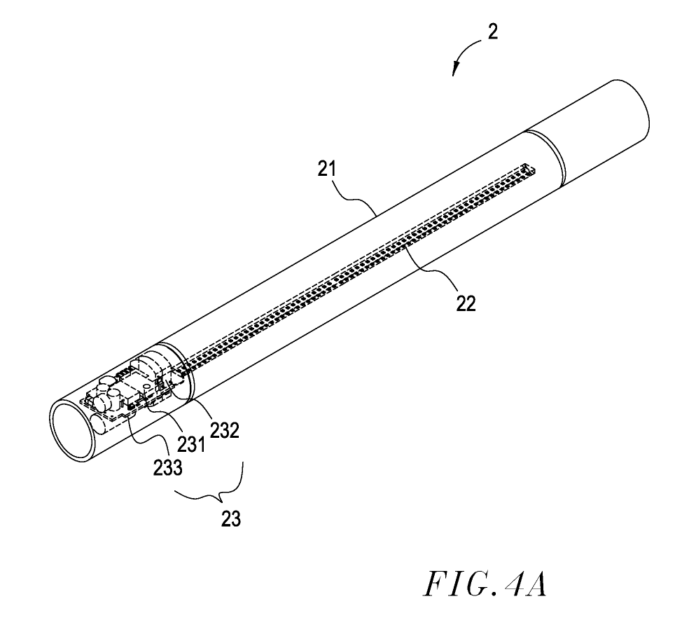

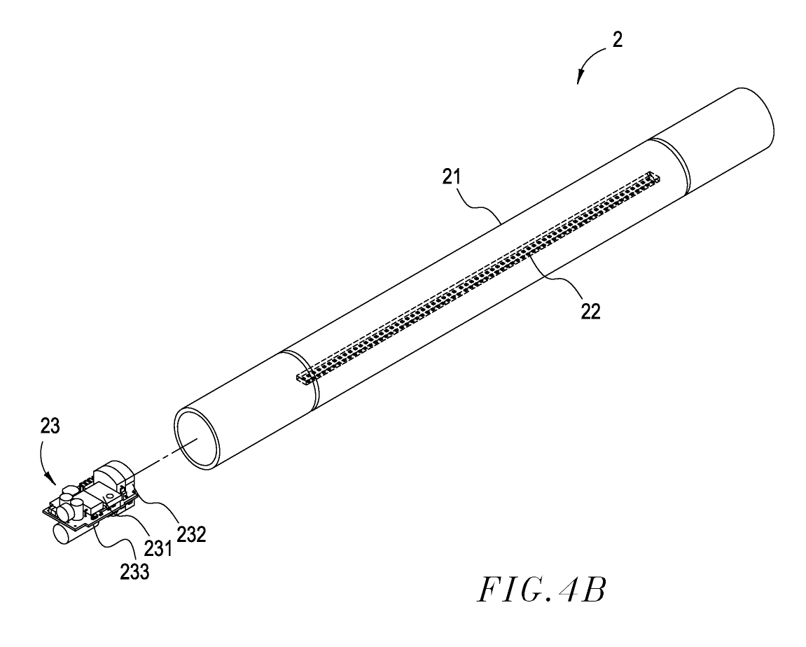

Therefore, as shown in FIGS. 4A and 4B, the LED lamp tube comprises a lampshade 21 and at least an LED lamp strap 22. Herein the LED lamp strap 22 is installed inside the lampshade 21, and, due to upright placement of the large-sized electronic component 232 on one side of the drive circuit board 233, the drive circuit structure 23 is allowed to be disposed on one side of the interior of the lampshade 21 and connected to the LED lamp strap 22; in addition, the drive circuit structure 23 is used to drive the LEDs 221 of the LED lamp strap 22 to illuminate.

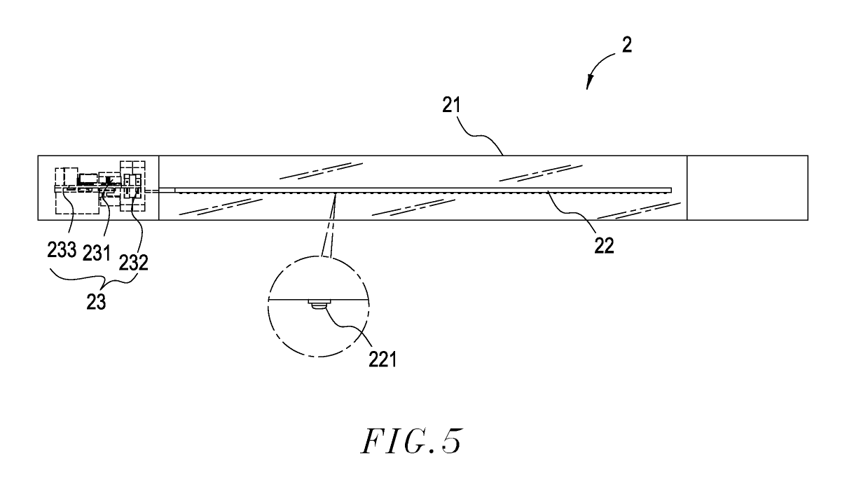

Moreover, if the large-sized electronic component 232 is inserted on the drive circuit board 233, then the height thereof will inevitably exceed the interior of the lampshade 21. Consequently, as shown in FIG. 5, making the large-sized electronic component 232 be disposed upright on one side of the drive circuit board 233 can successfully resolve such an issue, thereby driving an entire piece of the LED lamp strap 22 in the LED lamp tube 2.

Compared with other conventional technologies, the drive circuit structure for LED lamp tube provided by the present invention further offers the following advantages:

1. The present invention allows to prevent the large-sized electronic component from occupying larger accommodation space in order to drive an entire piece of the LED lamp strap in the LED lamp tube with a drive circuit structure such that the whole LED lamp tube illuminates completely and uniformly.

2. Seeing that, in the present invention, the electronic component of increased size is installed on any side of the drive circuit board, the accommodation space occupied by the drive circuit structure can be effectively reduced, so it is possible to drive the entire piece of the LED lamp strap by means of the drive circuit board in the LED lamp tube.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. A drive circuit structure for light-emitting diode (LED) lamp tube, wherein the LED lamp tube comprises a lampshade, at least an LED lamp strap installed in the interior of the lampshade and at least a drive circuit structure installed on any side of the interior of the lampshade, characterized in that: the drive circuit structure includes multiple general-sized electronic components, at least a large-sized electronic component and a drive circuit board, in which such general-sized electronic components are inserted on any plane of the drive circuit board, and the large-sized electronic component can be disposed upright on any side of the drive circuit board.

2. The drive circuit structure for LED lamp tube according to claim 1, wherein the LED lamp strap includes a plurality of LEDs.

3. The drive circuit structure for LED lamp tube according to claim 1, wherein the lampshade is of a long-strapped shape.

4. The drive circuit structure for LED lamp tube according to claim 1, wherein the drive circuit structure is connected with the LED lamp strap, and the drive circuit structure is used to drive the LED lamp strap to illuminate.

5. The drive circuit structure for LED lamp tube according to claim 1, wherein the general-sized electronic components can be electronic components like resistors or capacitors and so forth.

6. The drive circuit structure for LED lamp tube according to claim 1, wherein the large-sized electronic component is a transformer used to supply electric power required for the drive circuit board and the LED lamp strap to illuminate.
